(19) United States
(12) Patent Application Publication
(10) Pub. No.: US 2023/0255855 A1
(43) Pub. Date: Aug. 17, 2023

(54) System and device for a pill organizing hydration bottle

(71) Applicant: Michellia Sergeev, Brooklyn, NY (US)

(72) Inventor: Michellia Sergeev, Brooklyn, NY (US)

(21) Appl. No.: 17/671,971

(22) Filed: Feb. 15, 2022

(51) Int. Cl. A61J 7/04; A45F 3/18

(52) U.S. Cl. CPC A61J 7/0454; A45F 3/18; A61J 7/0481; A45F 2003/003

(57) ABSTRACT

A pill organizing hydration bottle, includes a bottle assembly with a main bottle body for storing a liquid; and a pill organizer assembly, including a rotatable cover assembly with a cover aperture, and a pill organizer base with a plurality of compartments, each with a compartment interior for storing pills, such that the cover assembly is detachably connectable to the bottle assembly; such that the pill organizing hydration bottle is configured to allow access to the organizer interior when the pill organizer base is detached from the main bottle body and the cover body is rotated to a selected position, such that the cover aperture is aligned with the opening of a selected compartment of the plurality of compartments, such that the cover aperture provides access to the compartment interior of the selected compartment.

### CROSS-REFERENCE TO RELATED APPLICATIONS

N/A.

### FIELD OF THE INVENTION

The present invention relates generally to the field of health and wellness, and more particularly to methods and systems for hydration and pill storage.

### BACKGROUND OF THE INVENTION

Hydration is an important part of daily life, and as daily life has become more fast paced, it has become increasingly important to have a portable source of hydration. In addition to hydration, many people's health is also dependent upon the routine ingestion of medication or supplements in pill or capsule form. Many of these pills can be cumbersome to swallow and are therefore simultaneously ingested with a liquid. It is also easy to forget a routine task, such as ingesting medication, and it is often unsafe or embarrassing to transport pills in their original packaging or in a daily pill organizer. To address the problems of hydration and the timely, discreet ingestion of pills, a system for hydration and pill storage is needed. Current options are limited in both the stability and privacy of the pill storage compartment.

As such, considering the foregoing, it may be appreciated that there continues to be a need for novel and improved devices and methods for portable hydration and safe, discreet pill storage.

### SUMMARY OF THE INVENTION

The foregoing needs are met, to a great extent, by the present invention, wherein in aspects of this invention, enhancements are provided to the existing models of pill storage devices and methods.

In an embodiment, a pill organizing hydration bottle can include:
a) a bottle assembly, which can include:
   i. a main bottle body, which can be configured as a container for storing a liquid for drinking; and
b) a pill organizer assembly, which can include:
   i. a cover assembly, which can include a cover body, which can include a cover aperture; and
   ii. a pill organizer base, which includes an organizer interior, which can be configured to contain a plurality of pills, wherein the pill organizer can further include a plurality of compartments, each including an opening and a compartment interior, wherein the opening provides access to a compartment interior of a corresponding compartment;
   wherein the pill organizer base can be rotatably attached to the cover body;
wherein the pill organizer assembly can be detachably connected to the main bottle body;
such that the pill organizing hydration bottle can be configured to allow access to the organizer interior when the pill organizer base is detached from the main bottle body and the cover body is rotated to a selected position, such that the cover aperture is aligned with the opening of a selected compartment of the plurality of compartments, such that the cover aperture provides access to the compartment interior of the selected compartment.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a top perspective view of a pill organizing hydration bottle, according to an embodiment of the invention.

FIG. 2A is an exploded top perspective view of a pill organizing hydration bottle, according to an embodiment of the invention.

FIG. 2B is an exploded bottom perspective view of a pill organizing hydration bottle, according to an embodiment of the invention.

FIG. 3A is a top perspective view of a detachable pill organizer assembly, according to an embodiment of the invention.

FIG. 3B is a top view of a detachable pill organizer assembly, according to an embodiment of the invention.

FIG. 3C is a front view of a detachable pill organizer assembly, according to an embodiment of the invention.

FIG. 3D is a top view of a detachable pill organizer assembly, according to an embodiment of the invention.

FIG. 3E is a side view of a rotatable cover assembly, according to an embodiment of the invention.

FIG. 4A is a top perspective view of a pill organizing hydration bottle base, according to an embodiment of the invention.

FIG. 4B is a top view of a pill organizing hydration bottle base with a transparent cover body, according to an embodiment of the invention.

FIG. 4C is a perspective section view of a pill organizing hydration bottle base, according to an embodiment of the invention.

FIG. 4D is a top view of a center portion of a pill organizing hydration bottle base, according to an embodiment of the invention.

FIG. 4E is a front view of a pill organizing hydration bottle base, according to an embodiment of the invention.

FIG. 4F is a front section view of a pill organizing hydration bottle base, according to an embodiment of the invention.

FIG. 5A is a top perspective view of a pill organizing hydration bottle, according to an embodiment of the invention.

FIG. 5B is a front section view of a pill organizing hydration bottle, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

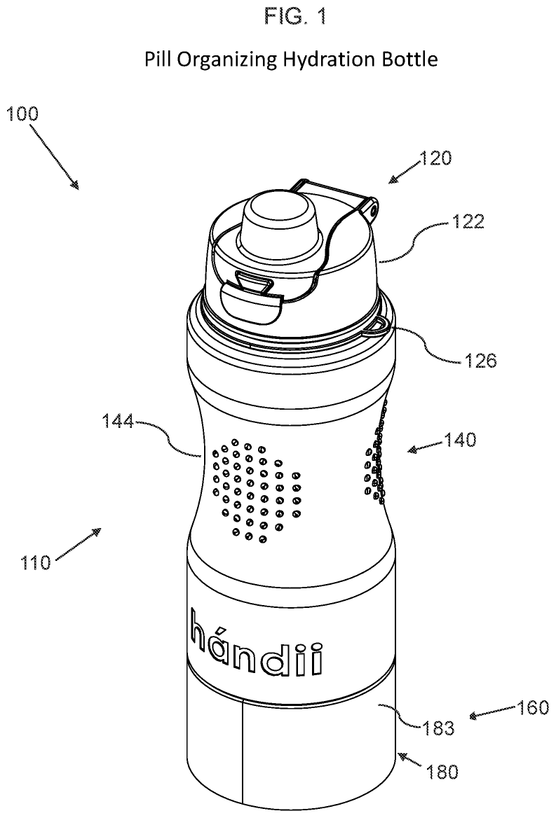

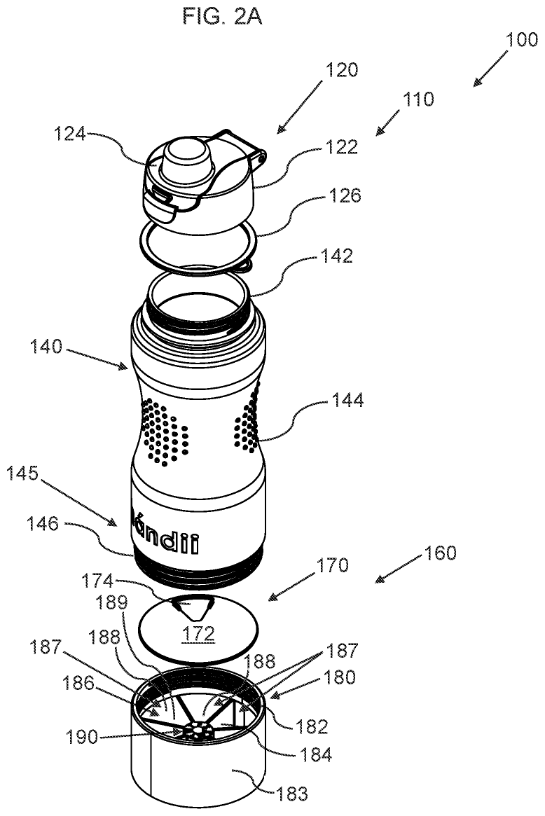

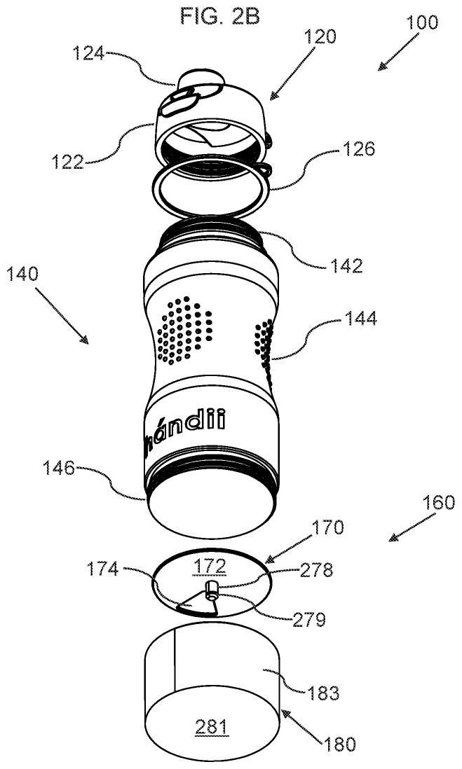

In the following, we describe the structure of an embodiment of a system for a pill organizing hydration bottle 100 with reference to FIGS. 1, 2A, and 2B, in such manner that like reference numerals refer to like components throughout; a convention that we shall employ for the remainder of this specification.

In an embodiment, as shown in FIGS. 1, 2A, and 2B, a system for a pill organizing hydration bottle 100 can include:
a) a bottle assembly 110, as shown in FIGS. 1, 2A, and 2B, which can include a cavity with impermeable walls, which can also include an outer threaded top portion and an outer threaded bottom portion; and
b) a detachable pill organizer assembly 160, as shown in FIGS. 2A-2B, 3A, 3B, 3C, 4A-4B, and 4C, which can include at least one cavity, which can be used as a storage device, and which can also include a threaded inner wall;
wherein the bottle assembly 110, can be detachably connected to the detachable pill organizer assembly 160.

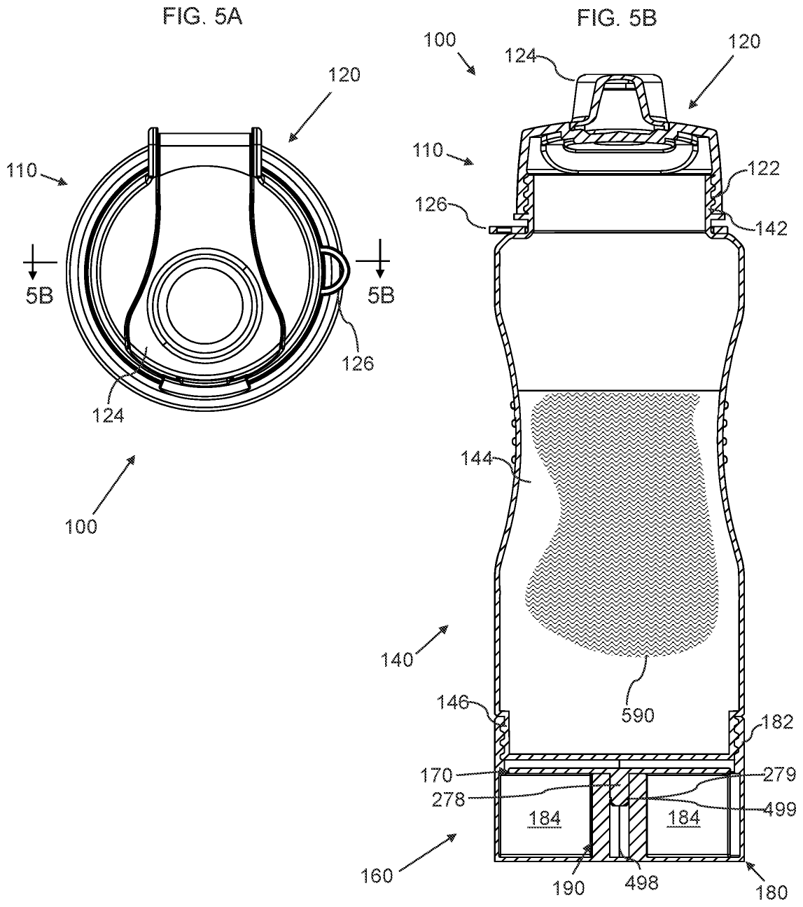

In a related embodiment, a bottle assembly 110, as shown in FIGS. 1 and 2A-2B, further comprises:
a) a sealable bottle top 120, as shown in FIGS. 1 and 2A-2B, which can include:
   i. top body portion 122, which for example can be comprised of an impermeable metal, ceramic, or polymer material, or a plurality thereof, and which can include a bottle top aperture, and which can also be configured to include a threaded inner wall;
   ii. a fluid sealing device 124, which can be configured to prevent the flow of fluids and solids into and out of the main bottle body 140;
   iii. a sealing ring 126, which can be a circular, flexible ring, fitted between the top body portion 122, and the main body neck 142, of the main bottle body 140;
   such that the fluid sealing device 124, can be fastened to the top body portion 122 of the sealable bottle top 120, and the sealing ring 126, can be flush with the main body neck 142 and the top body portion 122 to prevent the flow of fluids and solids into and out of the bottle assembly 110; and
b) a main bottle body 140, as shown in FIGS. 1, 2A-2B, and 5B, which can be configured as a container for storing a liquid 590 for drinking, such as water, sports drink fluid, wherein the main bottle body 140 can include:
   i. a main body neck 142, which can be an opening on the top portion of the main bottle body 140, which can include an outer threaded wall;
   ii. a fluid containment portion 144, which can be a cylindrical container comprised of metal or polymer material, or a plurality thereof, which can be permanently sealed on one end, and which can include an impermeable lining;
   iii. a main body bottom 145, which can include a body fastening structure 146, such as outer threading, a snap-lock connector, or some other detachable fastening structure, which can be connected to the detachable pill organizer assembly 160; and
   such that the main body neck 142 can be fastened securely to the top body portion 122, of the bottle assembly 110, and the main body bottom 145, can be fastened securely to a detachable pill organizer assembly 160.

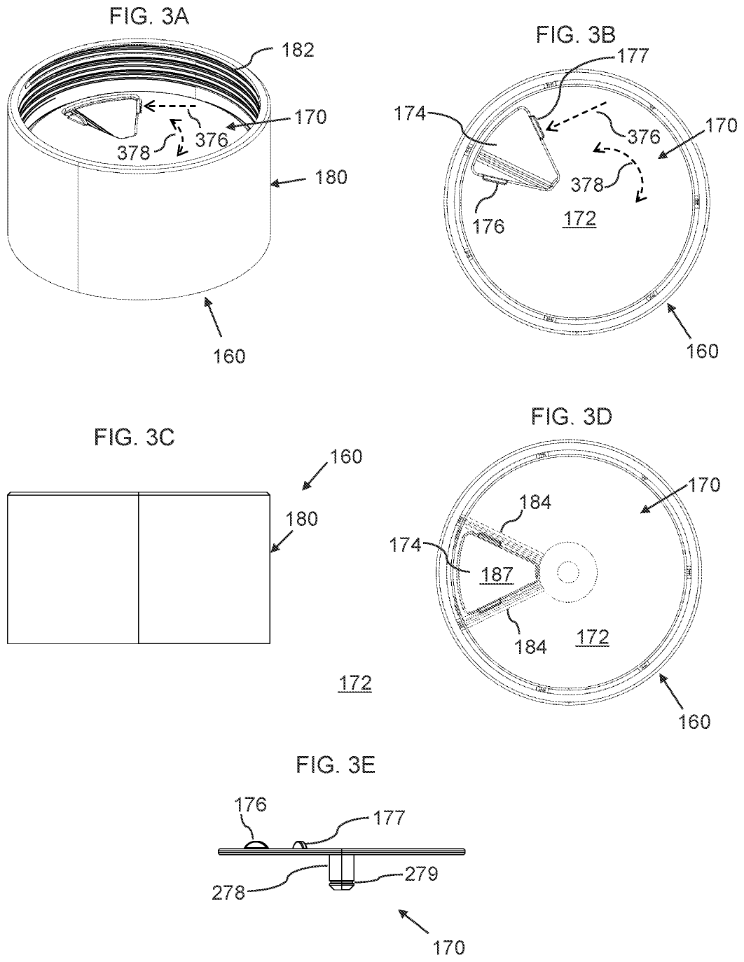

In a related embodiment, a detachable pill organizer assembly 160, as shown in FIGS. 2A-2B, 3A-3C, 4A-4F, and 5B, further comprises:
a) a rotatable cover assembly 170, as shown in FIGS. 2A-2B, 3A, 3B, 3D, 3E, and 4B, which can be configured to create a cover aperture 174, in the top portion of the detachable pill organizer assembly 160, which can further include:
   i. a cover body 172, which can be configured to be a flat cylindrical plate, wherein the cover body 172 can further include (i.e. be configured with):
      1. a cover aperture 174, which can be configured to allow or restrict access to a detachable pill organizer base 180;
      2. at least a first cover tab 176, which can be a first protruding member from the cover body 172;
      3. a second cover tab 177, which can be a second protruding member from the cover body 172; and
   ii. a cover attachment structure 278, which can be an elongated member, which can protrude from a center of a bottom surface of the cover body 172, and can be configured to be inserted into a center structure aperture 498;
   iii. an attachment structure depression 279, which can be configured to create a detachable attachment with cover locking mechanism 499, of the center structure 190;
   such that a lateral force 376 can be applied to the first cover tab 176, of the cover body 172, such that the rotatable cover assembly 170, can rotate 378, such that the rotation 378 permits adjustment of a position of the cover aperture 174, such that the cover aperture 174 can be aligned between successive organizer wall members 184, of detachable pill organizer base 180, as shown in FIG. 3D; and
b) a detachable pill organizer base 180, as shown in FIGS. 2A-2B, 3A, 3B, 3D, 3E, and 4A-4D, which can include at least one cavity section, wherein the detachable pill organizer base 180 can include an organizer interior 186, which can be configured to contain a plurality of pills 488, 489, wherein the pill organizer base 180 can further include a plurality of compartments 187, each comprising an opening 188, which provides access to a compartment interior 189, wherein the detachable pill organizer base 180 can further include:
   i. a base fastening structure 182, which can be configured as a threading on an inner surface of a peripheral side wall 183 of the pill organizer base 180;
   such that the base fastening structure 182 is configured to detachably connect to the body fastening structure 146;
   ii. a center structure 190, which can be configured to be a protruding member of the pill organizer base 180, wherein the center structure 190, can further include:
      1. a compartment identification system 490, which can be configured to be the first letter of each day of the week, positioned adjacent to a corresponding compartment 187;
      2. a center structure aperture 498, which can be configured to create a detachable attachment with the cover attachment structure 278;
      3. a cover locking mechanism 499, which can be configured as a protrusion from the wall of the center structure aperture 498;
      such that the cover attachment structure can be inserted into the center structure aperture, such that the cover attachment structure is configured to be rotatable inside the center structure aperture; and
   iii. an organizer wall member 184, which can be configured to attach the inner wall of the detachable pill organizer base 180, to the center structure 190;
whereby the base fastening structure 182, of the detachable pill organizer base 180, of the detachable pill organizer assembly 160, can be detachably connected to the main body bottom 145, of the main bottle body 140, of the bottle assembly 110; and
such that the rotatable cover assembly 170, of the detachable pill organizer assembly 160, can be positioned above the detachable pill organizer base 180, of the detachable pill organizer assembly 160, such that the cover attachment structure 278, of the rotatable cover assembly 170, can be detachably attached to the center structure 190, of the detachable pill organizer base 180, by means of the interface of a cover locking mechanism 499, of the center structure 190, and an attachment structure depression 279, of the rotatable cover assembly 170; and
such that the organizer wall member 184, or a plurality thereof, can be configured to attach the center structure 190, to the inner wall of the detachable pill organizer base 180, such that the cavity section of the detachable pill organizer base 180, is segmented into smaller storage compartments; and
such that the cover aperture 174, allows limited access to the cavity of the detachable pill organizer base 180, when the detachable pill organizer assembly 160, is detached from the bottle assembly 110, and such that the main body bottom 145, of the main bottle body 140, acts as a cover for the cover aperture 174, while the bottle assembly 110, is detachably attached to the detachable pill organizer assembly 160;
such that the pill organizing hydration bottle 100 is configured to allow access to the organizer interior 186 when the pill organizer base 180 is detached from the main bottle body 140 and the cover body 172 is rotated to a selected position, such that the cover aperture 174 is aligned with the opening of a selected compartment 187 of the plurality of compartments 187, such that the cover aperture 174 provides access to the compartment interior 189 of the selected compartment 187.

In a related embodiment, the bottle assembly 110, can also be configured to include an insulating layer, such as a double-wall foam or double-wall vacuum insulation.

In a related embodiment, the top body portion 122, can be made of a metal alloy, such as for example stainless steel, including a 18/8 steel alloy, or aluminum, including a 5052 aluminum.

In a related embodiment, the top body portion 122, can be made of a polymer material, such as for example plastic, including polyethylene terephthalate.

In a related embodiment, the fluid sealing device 124, can be a threaded fastener, a snap-fit fastener, or some other fastening device.

In a related embodiment, the sealing ring 126, can be configured to be detachably attached to a strap or lanyard.

In a related embodiment, the fluid containment portion 144, can be made of a metal alloy, such as for example stainless steel, including a 18/8 steel alloy, or aluminum, including a 5052 aluminum.

In a related embodiment, the fluid containment portion 144, can be made of a polymer material, such as for example plastic, including polyethylene terephthalate.

In a related embodiment, a compartment identification system 490, can be configured to consist of a protruding or engraved, number or letter above each cavity created by the organizer wall member 184, between the center structure 190, and the detachable pill organizer base 180, wall.

In another related embodiment, as show in FIGS. 2A-2B, 3A, and 3B the rotatable cover assembly 170 can include a cover aperture 174, that can be triangular, circular, or rectangular in shape, wherein the aperture can have rounded or flat corners.

Thus, in various related embodiments, the pill organizing hydration bottle 100 combines a water bottle with a pill organizer, to provide easy access to supplements, vitamins, and medications in different environments, such as at home or in a fitness center.

In yet another related embodiment, the bottle assembly 110, can have a fluid storage volume capacity of 8 to 32 ounces.

In a further related embodiment, and each cavity section in the detachable pill organizer base 180, can hold 12 medium size capsules or pills.

In still yet another related embodiment, the sealable bottle top 120, can include a leak proof and snap-seal lid, and can also include a chug spout for easy pill swallowing.

In another related embodiment, the base fastening structure 182, of the detachable pill organizer base 180, can be configured to be a threaded connector, a hinge and latch, a snap fit, or some other form of connector.

In a related embodiment, the main bottle body 140, can include a grooved surface with protrusions, for a more secure grip.

Thus, in an embodiment, as shown in FIGS. 1, 2A-2B, 3A-3C, 4A-4F, and 5B a pill organizing hydration bottle 100 can include:
a) a bottle assembly 110, which can include:
   i. a main bottle body 140, which can be configured as a container for storing a liquid 590 for drinking, such as water or a sports drink fluid; and
b) a pill organizer assembly 160, which can include:
   i. a cover assembly 170, which can include a cover body 172, which can include a cover aperture 174; and
   ii. a pill organizer base 180, which includes an organizer interior 186, which can be configured to contain a plurality of pills 488, 489, wherein the pill organizer can further include a plurality of compartments 187, each including an opening 188 and a compartment interior 189, wherein the opening 188 provides access to a compartment interior 189 of a corresponding compartment 187;
   wherein the pill organizer base 180 can be rotatably attached to the cover body 172, such that the cover body 172 covers a top opening of the organizer interior 186;
wherein the pill organizer assembly 160 can be detachably connected to the main bottle body 140;
such that the pill organizing hydration bottle 100 can be configured to allow access to the organizer interior 186 when the pill organizer base 180 is detached from the main bottle body 140 and the cover body 172 is rotated to a selected position, such that the cover aperture 174 is aligned with the opening of a selected compartment 187 of the plurality of compartments 187, such that the cover aperture 174 provides access to the compartment interior 189 of the selected compartment 187, as shown in FIG. 3D, which shows successive organizer wall members 184 (that form the selected compartment 187) in dotted lines (as they are hidden under the cover body 172).

in a related embodiment,
a) the cover assembly 170 can further include:
   i. a cover attachment structure 278, which protrudes downward from a center of a bottom surface of the cover body 172; and
b) the pill organizer base 180 can further include:
   i. a center structure 190, which comprises a center structure aperture 498;
   such that the cover attachment structure 278 is inserted into the center structure aperture 498, such that the cover attachment structure 278 is configured to be rotatable inside the center structure aperture 498.

in a further related embodiment,
a) the cover attachment structure 278 can further include:
   i. an elongated member, which can be configured with a locking indention 279, which encircles a surface of the elongated member; and
b) the center structure 190 can be configured with a locking protrusion 499, which encircles a surface of the center structure 190 inside the center structure aperture 498 of the center structure 190;
such that the locking protrusion 499 snaps into the locking indentation 279, such that the cover attachment structure 278 is detachably secured in position, when the cover attachment structure 278 is inserted into the center structure aperture 498.

in another related embodiment,
a) the main bottle body 140 can further include:
   i. a body fastening structure 146; and
b) the pill organizer base 180 can further include:
   i. a base fastening structure 182;
such that the base fastening structure 182 is configured to detachably connect to the body fastening structure 146.

in a further related embodiment,
a) the body fastening structure 146 can be configured as a first threading on an outer surface of a bottom portion of the main bottle body 140;
b) the pill organizer base 180 can further include a peripheral side wall 183; and
c) the base fastening structure can be configured as a second threading on an inner surface of the peripheral side wall 183 of the pill organizer base 180;
such that the second threading of the pill organizer base 180 is configured to screw onto the first threading of the main bottle body 140.

in yet another related embodiment, the pill organizer base 180 can further include:
a) a bottom plate 281;
b) a peripheral side wall 183, which protrudes vertically upward from a periphery of the bottom plate 281, such that the bottom plate 281 and the peripheral side wall 183 form the organizer interior 186;
c) a center structure 190, which protrudes vertically upward from a center of the bottom plate 281; and
d) at least one divider wall 184, which is mounted between the center structure and the peripheral side wall 183, such that the at least one divider wall divides the organizer interior 186 into the plurality of compartments 187.

In a related embodiment, the cover assembly 170 further can further include:
a) at least one cover tab, which can be positioned on a top of the cover body 172, such that the at least one cover tab protrudes from the cover body 172;
such that the cover assembly 170 rotates 378 when a lateral force 376 is applied to the at least one cover tab 176, 177.

In a further related embodiment, the at least one cover tab can further include:
a) a first cover tab, which can be positioned on a first side of the cover aperture 174, adjacent to the cover aperture 174; and
b) a second cover tab, which can be positioned on a second side of the cover aperture 174, adjacent to the cover aperture 174.

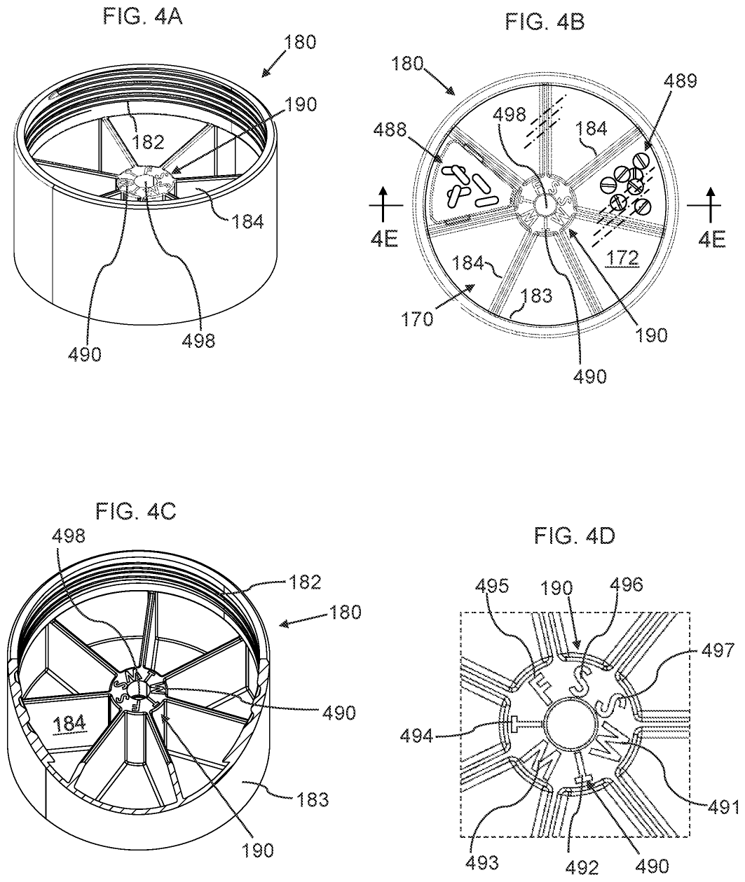

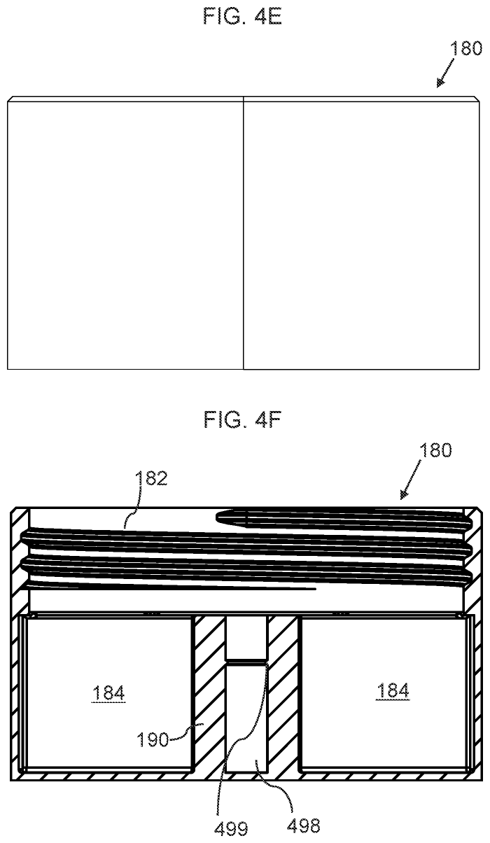

In a further related embodiment, as shown in FIG. 4D, the pill organizer base 180 can further include:
a) a compartment identification system 490, which can be a plurality of compartment markings 491, 492, 493, 494, 495, 496, 497, which can be a plurality of day markings 491, 492, 493, 494, 495, 496, 497 which can be printed and/or protruding/raised or indented/engraved, wherein the day markings 491, 492, 493, 494, 495, 496, 497 can be positioned on a top surface of the center structure 190;
wherein the cover body 172 can be transparent, such that the compartment markings 491, 492, 493, 494, 495, 496, 497 are visible through the cover body 172, as shown in FIG. 4B;
wherein the pill organizer base 180 can include seven compartments 187, such that each day marking 491, 492, 493, 494, 495, 496, 497 is positioned adjacent to (or aligned with) a corresponding compartment 187; wherein the day markings 491, 492, 493, 494, 495, 496, 497 can include:
   i. a Monday/first day marking 491, which can be the text “M”;
   ii. a Tuesday/second day marking 492, which can be the text “T”;
   iii. a Wednesday/third day marking 493, which can be the text “W”;
   iv. a Thursday/fourth day marking 494, which can be the text “T”;
   v. a Friday/fifth day marking 495, which can be the text “F”;
   vi. a Saturday/sixth day marking 496, which can be the text “5”; and
   vii. a Sunday/seventh day marking 497, which can be the text “5”.

Here has thus been described a multitude of embodiments of the pill organizing hydration bottle 100, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent and should be considered fully included in this specification and the claims appended hereto.

Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. A pill organizing hydration bottle, comprising:
a) a bottle assembly, comprising:
a main bottle body, which is configured as a container for storing a liquid; and
b) a pill organizer assembly, comprising:
a cover assembly, which comprises a cover body, which comprises a cover aperture; and
a pill organizer base, which comprises an organizer interior, which is configured to contain a plurality of pills, wherein the pill organizer base further comprises a plurality of compartments, each comprising an opening, which provides access to a compartment interior;
wherein the cover body is rotatably attached to the pill organizer base, such that the cover body covers a top opening of the organizer interior;
wherein the pill organizer assembly is detachably connected to the main bottle body;
such that the pill organizing hydration bottle is configured to allow access to the organizer interior when the pill organizer base is detached from the main bottle body and the cover body is rotated to a selected position, such that the cover aperture is aligned with the opening of a selected compartment of the plurality of compartments, such that the cover aperture provides access to the compartment interior of the selected compartment.

2. The pill organizing hydration bottle of claim 1,
wherein the cover assembly further comprises:
a cover attachment structure, which protrudes downward from a center of a bottom surface of the cover body; and
wherein the pill organizer base further comprises:
a center structure, which comprises a center structure aperture;
such that the cover attachment structure is inserted into the center structure aperture, such that the cover attachment structure is configured to be rotatable inside the center structure aperture.

3. The pill organizing hydration bottle of claim 2,
wherein the cover attachment structure further comprises:
an elongated member, which is configured with a locking indention, which encircles a surface of the elongated member; and
wherein the center structure is configured with a locking protrusion, which encircles a surface of the center structure inside the center structure aperture;
such that the locking protrusion is configured to snap into the locking indentation, such that the cover attachment structure is detachably secured in position, when the cover attachment structure is inserted into the center structure aperture.

4. The pill organizing hydration bottle of claim 1,
wherein the main bottle body further comprises:
a body fastening structure; and
wherein the pill organizer base further comprises:
a base fastening structure;
such that the base fastening structure is configured to detachably connect to the body fastening structure.

5. The pill organizing hydration bottle of claim 4,
wherein the body fastening structure is configured as a first threading on an outer surface of a bottom portion of the main bottle body;
wherein the pill organizer base further comprises a peripheral side wall; and
wherein the base fastening structure is configured as a second threading on an inner surface of the peripheral side wall of the pill organizer base;
such that the second threading of the pill organizer base is configured to screw onto the first threading of the main bottle body.

6. The pill organizing hydration bottle of claim 1, wherein the pill organizer base further comprises:
a) a bottom plate;
b) a peripheral side wall, which protrudes vertically upward from a periphery of the bottom plate, such that the bottom plate and the peripheral side wall form the organizer interior;
c) a center structure, which protrudes vertically upward from a center of the bottom plate; and
d) at least one divider wall, which is mounted between the center structure and the peripheral side wall, such that the at least one divider wall divides the organizer interior into the plurality of compartments.

7. The pill organizing hydration bottle of claim 1, wherein the cover assembly further comprises:
at least one cover tab, which is positioned on a top of the cover body, such that the at least one cover tab protrudes from the cover body;
such that the cover assembly is configured to rotate when a lateral force is applied to the at least one cover tab.

8. The pill organizing hydration bottle of claim 7, wherein the at least one cover tab further comprises:
a) a first cover tab, which is positioned on a first side of the cover aperture, adjacent to the cover aperture; and
b) a second cover tab, which is positioned on a second side of the cover aperture, adjacent to the cover aperture.

9. The pill organizing hydration bottle of claim 2, wherein the pill organizer base further comprises:
a compartment identification system, comprising a plurality of compartment markings, which are positioned on a top surface of the center structure;
such that each compartment marking is positioned adjacent to a corresponding compartment;
wherein the cover body is transparent, such that the compartment markings are visible through the cover body.

10. The pill organizing hydration bottle of claim 9, wherein the pill organizer base comprises seven compartments, such that the compartment markings are day markings, comprising:
a) a Monday day marking;
b) a Tuesday day marking;
c) a Wednesday day marking;
d) a Thursday day marking;
e) a Friday day marking;
f) a Saturday day marking; and
g) a Sunday day marking.

11. A pill organizing hydration bottle, comprising:
a) a bottle assembly, comprising:
a main bottle body, which is configured as a container for storing a liquid; and
b) a pill organizer assembly, comprising:
a pill organizer base, which comprises an organizer interior, which is configured to contain a plurality of pills;
wherein the pill organizer assembly is detachably connected to the main bottle body;
such that the pill organizing hydration bottle is configured to allow access to the organizer interior when the pill organizer base is detached from the main bottle body.

12. The pill organizing hydration bottle of claim 11,
wherein the pill organizer assembly further comprises:
a cover assembly, which comprises a cover body, which comprises a cover aperture; and
wherein the pill organizer base further comprises:
a plurality of compartments, each comprising:
an opening; and
a compartment interior;
such that the opening provides access to the compartment interior, such that the cover body covers a top opening of the organizer interior;
wherein the cover body is rotatably attached to the pill organizer base;
such that when the pill organizer base is detached from the main bottle body and the cover body is rotated to a selected position, such that the cover aperture is aligned with the opening of a selected compartment of the plurality of compartments, the cover aperture provides access to the compartment interior of the selected compartment.

13. The pill organizing hydration bottle of claim 12,
wherein the cover assembly further comprises:
a cover attachment structure, which protrudes downward from a center of a bottom surface of the cover body; and
wherein the pill organizer base further comprises:
a center structure, which comprises a center structure aperture;
such that the cover attachment structure is inserted into the center structure aperture, such that the cover attachment structure is configured to be rotatable inside the center structure aperture.

14. The pill organizing hydration bottle of claim 13,
wherein the cover attachment structure further comprises:
an elongated member, which is configured with a locking indention, which encircles a surface of the elongated member; and
wherein the center structure is configured with a locking protrusion, which encircles a surface of the center structure inside the center structure aperture;
such that the locking protrusion is configured to snap into the locking indentation, such that the cover attachment structure is detachably secured in position, when the cover attachment structure is inserted into the center structure aperture.

15. The pill organizing hydration bottle of claim 11,
wherein the main bottle body further comprises:
a body fastening structure; and
wherein the pill organizer base further comprises:
a base fastening structure;
such that the base fastening structure is configured to detachably connect to the body fastening structure.

16. The pill organizing hydration bottle of claim 15,
wherein the body fastening structure is configured as a first threading on an outer surface of a bottom portion of the main bottle body;
wherein the pill organizer base further comprises a peripheral side wall; and
wherein the base fastening structure is configured as a second threading on an inner surface of the peripheral side wall of the pill organizer base;
such that the second threading of the pill organizer base is configured to screw onto the first threading of the main bottle body.

17. The pill organizing hydration bottle of claim 12, wherein the pill organizer base further comprises:
a) a bottom plate;
b) a peripheral side wall, which protrudes vertically upward from a periphery of the bottom plate, such that the bottom plate and the peripheral side wall form the organizer interior;
c) a center structure, which protrudes vertically upward from a center of the bottom plate; and
d) at least one divider wall, which is mounted between the center structure and the peripheral side wall, such that the at least one divider wall divides the organizer interior into the plurality of compartments.

18. The pill organizing hydration bottle of claim 12,
wherein the cover assembly further comprises:
at least one cover tab, which is positioned on a top of the cover body, such that the at least one cover tab protrudes from the cover body;
such that the cover assembly is configured to rotate when a lateral force is applied to the at least one cover tab.

19. The pill organizing hydration bottle of claim 18, wherein the at least one cover tab further comprises:
a) a first cover tab, which is positioned on a first side of the cover aperture, adjacent to the cover aperture; and
b) a second cover tab, which is positioned on a second side of the cover aperture, adjacent to the cover aperture.

20. A pill organizing hydration bottle, comprising:
a) a bottle assembly, which is configured as a container for storing a liquid; and
b) a pill organizer assembly, comprising:
a pill organizer base, which comprises an organizer interior, which is configured to contain a plurality of pills;
wherein the pill organizer assembly is detachably connected to the bottle assembly;
such that the pill organizing hydration bottle is configured to allow access to the organizer interior when the pill organizer base is detached from the bottle assembly.

21. The pill organizing hydration bottle of claim 20,
wherein the pill organizer assembly further comprises:
a cover assembly, which comprises a cover body, which comprises a cover aperture; and
wherein the pill organizer base further comprises:
a plurality of compartments, each comprising:
an opening; and
a compartment interior;
such that the opening provides access to the compartment interior;
wherein the cover body is rotatably attached to the pill organizer base, such that the cover body covers a top opening of the organizer interior;
such that when the pill organizer base is detached from the bottle assembly and the cover body is rotated to a selected position, such that the cover aperture is aligned with the opening of a selected compartment of the plurality of compartments, the cover aperture provides access to the compartment interior of the selected compartment.

22. The pill organizing hydration bottle of claim 21,
wherein the cover assembly further comprises:
a cover attachment structure, which protrudes downward from a center of a bottom surface of the cover body; and
wherein the pill organizer base further comprises:
a center structure, which comprises a center structure aperture;
such that the cover attachment structure is inserted into the center structure aperture, such that the cover attachment structure is configured to be rotatable inside the center structure aperture.
